(19) United States
(12) Patent Application Publication
(10) Pub. No.: US 2007/0162736 A1
(43) Pub. Date: Jul. 12, 2007

(54) ELECTRONIC DEVICE WITH ACCELERATED BOOT PROCESS AND METHOD FOR THE SAME

(76) Inventors: Tung-Peng Wu, Taipei (TW); Wei-Te Hsu, Taipei (TW); Wen-Chin Lin, Taipei (TW)

Correspondence Address: SINORICA, LLC, 528 FALLSGROVE DRIVE, ROCKVILLE, MD, 20850, US

(21) Appl. No.: 11/462,409

(22) Filed: Aug. 4, 2006

Related U.S. Application Data
(60) Provisional application No. 60/757,852, filed on Jan. 11, 2006.

(51) Int. Cl. G06F 15/177; G06F 9/00

(52) U.S. Cl. 713/2

(57) ABSTRACT

An electronic device with accelerated boot process and a method for the same are proposed. When the host of the electronic device is in the off mode or standby mode, users can input a normal boot signal or a fast boot signal to activate the host. The boot signal is encoded by an encoder for producing a corresponding code. The host determines whether the input signal is the normal boot signal or the fast boot signal according to the received code. If the received code is the normal boot signal, the host performs a normal boot process. If the received code is the fast boot signal, an instant launcher directly launches application programs specified in the fast boot signal and blocks the start of unnecessary application programs. The boot process of the electronic device can be effectively accelerated, and users can define several boot modes themselves to meet different requirements.

### BACKGROUND OF THE INVENTION

1. Field of the Invention

The present invention relates to a boot process and, more particularly, to an electronic device with accelerated boot process and a method for the same.

2. Description of Related Art

The computer's boot process can generally be divided into two steps: a basic input/output system (BIOS) launch process and an operating system (OS) launch process. The BIOS includes some basic programs for computer operations and is stored in the read-only memory (ROM). Its primary function is to control the operations of the central processing unit (CPU) and every chip and various standard peripherals. When the BIOS activates the computer, it will first make sure whether all components are ready for operation, and then load the OS into the random access memory (RAM).

As shown in FIG. 1, after a user transmits a boot signal to a host 14 via a power on/off key 10 and a power on/off key controller 12, a BIOS 16 is first launched. The BIOS process includes the execution of some routine self-tests and the search of peripherals. The length of spending time mainly depends on the type of hardware platform. Next, an OS 18 is launched to search and link application programs which are stored on a startup directory or listed in a register 20. The link to each application program listed in the register 20 one by one will greatly increase the boot time. Especially, many linked application programs are unnecessary to the OS. Therefore, in order to shorten the boot time, a common practice is to enable or disable application programs that are run beforehand according to the user's command (e.g., the system configuration utility of the Windows 98). A user can use the system configuration utility to modify specific system information. Besides, the new Microsoft OS, Windows Vista, also provides built-in support which directly links the application programs during system startup. For instance, a playback key allows the system to enter a special playback mode after the system is launched. By pressing this shortcut key, the user can use the playback function in the shortest time (immediately after the system is launched).

Because all static and dynamic configuration data of Windows are stored in flash memory, the extra time taken for the initialization of the configuration data is commensurate with the time required for spin-up of harddisk. Therefore, the conventional methods cannot more effectively shorten the boot process. In other words, the present invention aims to propose an electronic device with accelerated boot process and a method for the same.

### SUMMARY OF THE INVENTION

To achieve these and other advantages and in order to overcome the disadvantages of the conventional method in accordance with the purpose of the invention as embodied and broadly described herein, the present invention provides an electronic device with accelerated boot process and a method for the same. In the accelerated boot process, unnecessary application programs are blocked and not activated. More, only application programs specified by the user are linked, therefore, the main object of the present invention can achieve the purpose of accelerating the boot process.

An object of the present invention is to provide an electronic device with accelerated boot process and a method for the same, in which the user can specify application programs to be launched or blocked in various modes. The boot signals corresponding to various modes are encoded with different codes.

To achieve the above object, in the present invention, a boot signal is input into an electronic device which is in the off mode or standby mode, and a host determines whether the boot signal is a normal boot signal or a fast boot signal. If the boot signal is the normal boot signal, a normal boot process is performed. If the boot signal is a fast boot signal, an instant launcher directly links and launches application programs specified by the fast boot signal, and blocks the start of unnecessary application programs specified by the user.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a block diagram showing a computer boot device in the prior art;

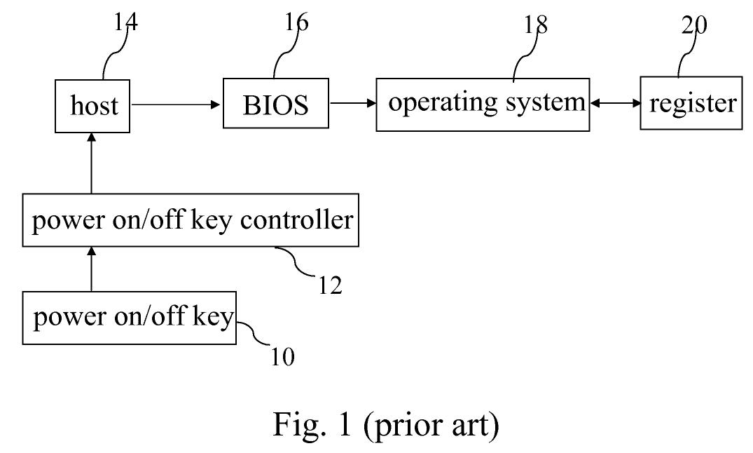

FIG. 2 is a block diagram showing an electronic device with accelerated boot process according to an embodiment of the present invention;

FIG. 3 is a flowchart showing a method for accelerating the boot process of an electronic device according to an embodiment of the present invention;

FIG. 4 is another flowchart showing a method for accelerating the boot process of an electronic device according to an embodiment of the present invention; and

FIG. 5 is a block diagram showing an electronic device with accelerated boot process according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The main function of the present invention is to accelerate the boot process of an electronic device. An instant launcher and hot keys capable of inputting fast boot signals are disposed in an electronic device, and work together during boot.

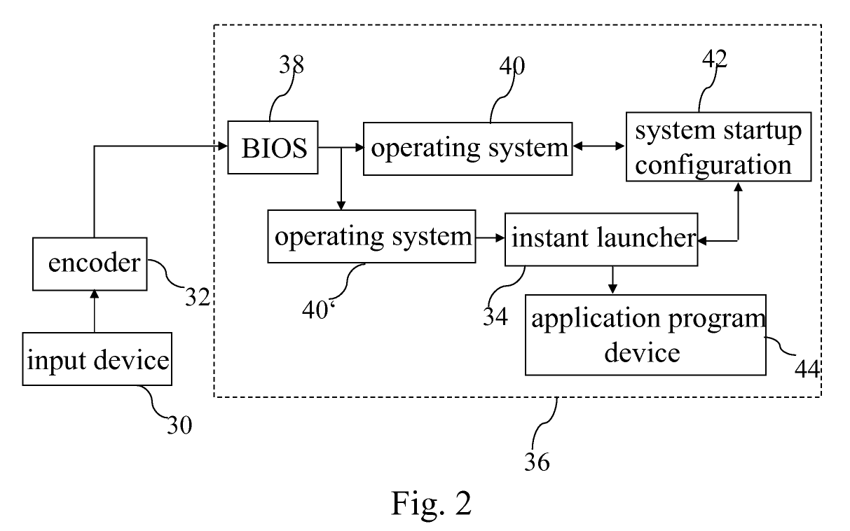

Exemplified with a personal computer, the instant launcher can be built in a host. As shown in FIG. 2, a host 36 comprises a basic input/output system (BIOS) for executing basic boot procedures and at least an application program device 44 for executing application programs. The user can input a boot signal via an input device 30 such as a power on/off key or a keyboard to activate the computer from the off mode or the standby mode. The boot signal can be a normal boot signal or a fast boot signal. The normal boot signal will direct the host 36 to perform a normal boot process. In the normal boot process, the BIOS 38 and an operating system (OS) 40 are launched, and application programs installed in a system startup configuration 42 are linked one by one. The fast boot signal is specified by the user, and includes several different signals. Each signal assigns the host 36 to enter a different fast boot mode. After the BIOS 38 and the OS 40 are launched, an instant launcher 34 directly links and launches application programs specified in the fast boot signal and blocks the start of unnecessary programs. Meanwhile, the loaded OS 40′ is the OS related to the specific fast boot mode and can be different from the OS of the normal boot process. Therefore, the input device 30 needs to have hot keys corresponding to these fast boot signals, and integrates original keys of the computer such as the power key. After the user presses a hot key, the boot signal can be encoded by an encoder 32. Each boot signal is encoded with a corresponding code so that the host 36 can recognize the received boot signal easily.

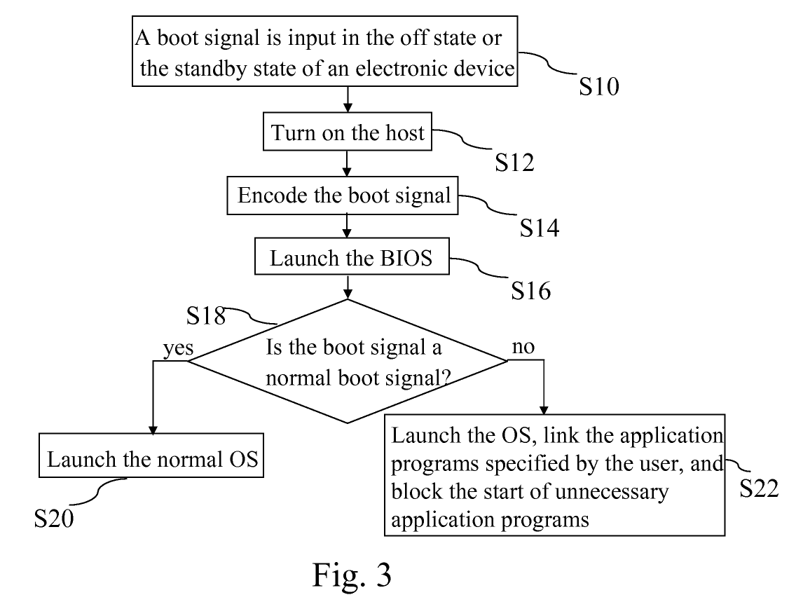

Please refer to FIG. 3, when the computer is in the off mode or the standby mode, the user first inputs a boot signal via the input device 30 (Step S10) to turn on the host 36 (Step S12). Next, the boot signal is transmitted to the encoder 32 and is encoded by the encoder 32 (Step S14). The boot signal could be a normal boot signal or a fast boot signal, and each is represented by its own code. The encoded boot signal is then transmitted to the host. After the BIOS is launched (Step S16), the host 36 determines whether the received boot signal is the normal boot signal (Step S18). If the boot signal is the normal boot signal, a normal boot process is performed (Step S20); otherwise, the related OS 40′ is launched and an instant launcher 34 blocks the start of unnecessary programs specified in the fast boot signal by the user and directly launches specified application programs (Step S22). The OS of the fast boot process needs not to be the same as that used by the normal boot process. The OS is related to the application programs specified in the fast boot signal.

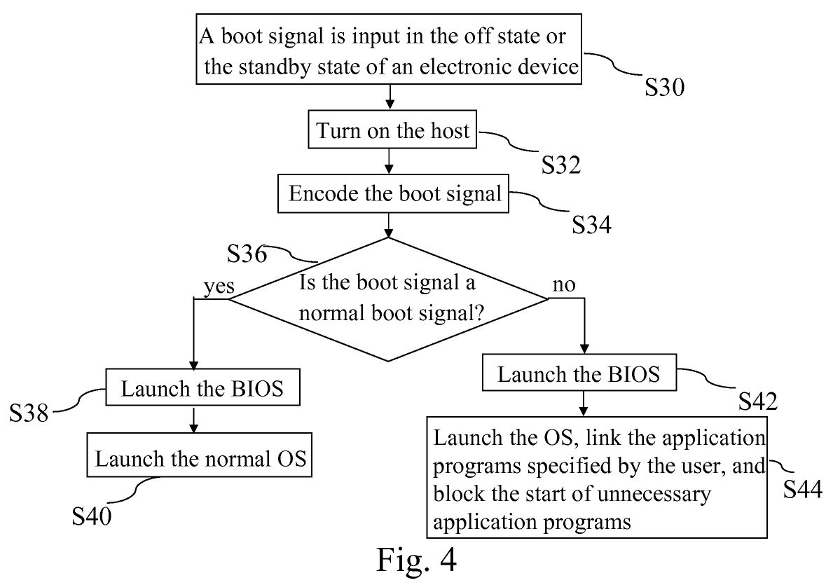

The determination of whether the received boot signal is the normal boot signal can also be carried out before the BIOS is launched. As shown in FIG. 4, the host 36 receives the encoded boot signal and immediately determines whether the received boot signal is the normal boot signal. If the input boot signal is the normal boot signal, the normal boot process from Step S38 to Step S40 is entered to launch the BIOS and the normal OS. If the boot signal is the fast boot signal, after the BIOS is launched (Step S42), the OS is activated to link application programs specified by the user, and the start of unnecessary application programs is blocked (Step S44).

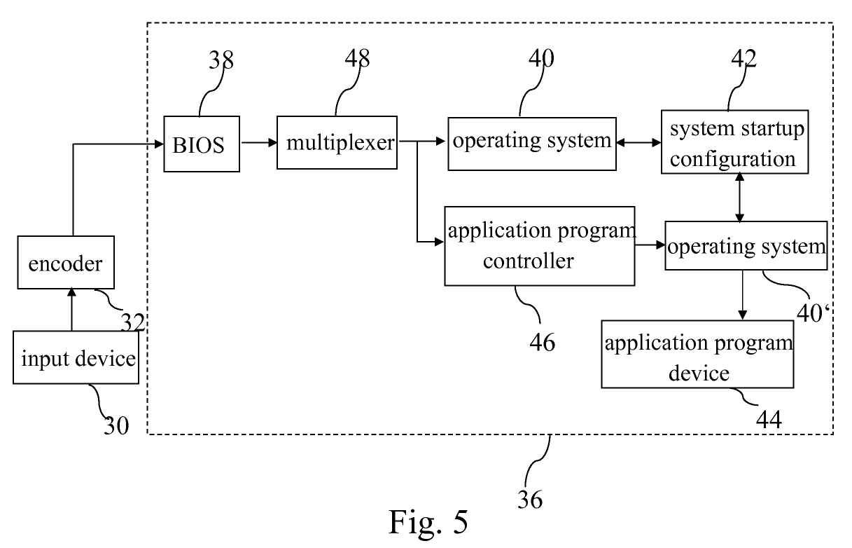

As shown in FIG. 5, the instant launcher can be built in an application program controller 46, too. The boot signal input by the user is first transmitted to the host 36 for activating the BIOS 38. If the boot signal is a fast boot signal, the BIOS 38 is linked to the application program controller 46 via a multiplexer 48. When the OS 40′ is launched, application programs specified by the user is linked, and the start of unnecessary application programs is blocked. If the boot signal is the normal boot signal, the OS is launched to perform the normal boot process.

To sum up, in the present invention, the user can first specify application programs to be launched or blocked in each fast boot signal. It provides the user to diversify self-defined boot procedures so as to meet the requirements in various different situations. Moreover, an instant launcher is used to directly launch or block these application programs as well as to accelerate the boot process. The user can immediately enter the operation mode after booting. In other words, other irrelevant application programs, such as antivirus software, do not need to be launched so that unnecessary steps and time are not required.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for accelerating boot process of an electronic device comprising the steps of:
a user inputting a boot signal to turn on said electronic device in a off mode or a standby mode of said electronic device;
determining whether said boot signal is a normal boot signal or a fast boot signal;
performing a normal boot process if said boot signal is said normal boot signal; and
performing a fast boot process to launch application programs specified in said fast boot signal and to block a start of specified unnecessary application programs if said boot signal is said fast boot signal.

2. The method for accelerating the boot process of an electronic device as claimed in claim 1, wherein said boot signal is input to said electronic device via an input device.

3. The method for accelerating the boot process of an electronic device as claimed in claim 1, wherein said fast boot signal includes several different signals, and each said different signals is corresponding to at least one specified application program.

4. The method for accelerating the boot process of an electronic device as claimed in claim 2, wherein said input device integrates original keys of said electronic device and at least a hot key capable of transmitting said fast boot signal.

5. The method for accelerating the boot process of an electronic device as claimed in claim 2, wherein said input device is a keyboard or a power on/off key.

6. The method for accelerating the boot process of an electronic device as claimed in claim 1, wherein the launch step of said application programs specified by said fast boot signal and the block step of said specified unnecessary application programs are carried out by an instant launcher, said instant launcher is activated after a BIOS and an OS are launched.

7. The method for accelerating the boot process of an electronic device as claimed in claim 1 further comprising a step of encoding said boot signals, wherein different codes corresponding to said boot signals are produced so that said electronic device can perform determination and boot process according to said codes.

8. An electronic device with accelerated boot process comprising:
an input device capable of inputting a normal boot signal or a fast boot signal; and
a host for receiving said normal boot signal or said fast boot signal in a off mode or a standby mode of said electronic device to perform a normal boot process or a fast boot process in which an instant launcher included in said host launches application programs specified in said fast boot signal and blocks a start of unnecessary application program.

9. The electronic device with accelerated boot process as claimed in claim 8, wherein said fast boot signal includes several different signals, and each said different signals is corresponding to at least one specified application program.

10. The electronic device with accelerated boot process as claimed in claim 8 further comprising an encoder, wherein said encoder generates different codes according to said boot signals and transmits said codes to said host so that said host can perform different boot processes according to said codes, a BIOS for executing basic boot steps and at least an application program device for executing said application programs, wherein said BIOS and said application program device are built in said host.

11. The electronic device with accelerated boot process as claimed in claim 8, wherein said input device integrates original keys of said electronic device and at least a hot key capable of transmitting said fast boot signal.

12. The electronic device with accelerated boot process as claimed in claim 8, wherein said electronic device is a computer, said input device is a keyboard or a power on/off key.

13. An electronic device with accelerated boot process comprising:
an input device capable of inputting a normal boot signal or a fast boot signal;
an application program controller for performing a fast boot process, an instant launcher included in said application program controller directly linking and launching application programs specified in said fast boot signal and blocking the start of unnecessary application programs; and
a host having a multiplexer, said host receiving said normal boot signal or said fast boot signal in a off mode or a standby mode of said electronic device and making use of said multiplexer to respectively perform a normal boot process or said fast boot process by using said program application controller.

14. The electronic device with accelerated boot process as claimed in claim 13, wherein said fast boot signal includes several different signals, and each said different signals is corresponding to at least one specified application program.

15. The electronic device with accelerated boot process as claimed in claim 13, wherein said host comprises a BIOS for executing basic boot steps and at least an application program device for executing said application programs.

16. The electronic device with accelerated boot process as claimed in claim 13 further comprising an encoder, wherein said encoder generates different codes according to said boot signals and transmits said codes to said host so that said host can perform different boot processes according to said codes, a BIOS for executing basic boot steps and at least an application program device for executing said application programs, wherein said BIOS and said application program device are built in said host.

17. The electronic device with accelerated boot process as claimed in claim 13, wherein said input device integrates original keys of said electronic device and at least a hot key capable of transmitting said fast boot signal.

18. The electronic device with accelerated boot process as claimed in claim 13, wherein said electronic device is a computer, said input device is a keyboard or a power on/off key.

19. The electronic device with accelerated boot process as claimed in claim 13, wherein said normal boot process comprises a basic input/output system (BIOS) launch process and an operating system (OS) launch process.

20. The electronic device with accelerated boot process as claimed in claim 13, wherein said application program controller can be built in said host.
